(19) United States
(12) Patent Application Publication
(10) Pub. No.: US 2024/0160028 A1
(43) Pub. Date: May 16, 2024

(54) FLAT OPTICS FOR LIGHT COUPLING

(71) Applicant: 2Pi Inc., Cambridge, MA (US)

(72) Inventors: Tian Gu, Acton, MA (US); Juejun Hu, Newton, MA (US); Xiaochen Sun, Chino Hills, CA (US); Fan Yang, Cambridge, MA (US); Hung-I Lin, Cambridge, MA (US)

(73) Assignee: 2Pi Inc., Cambridge, MA (US)

(21) Appl. No.: 18/508,217

(22) Filed: Nov. 13, 2023

Related U.S. Application Data
(60) Provisional application No. 63/424,227, filed on Nov. 10, 2022.

(51) Int. Cl. G02B 27/09; F21V 9/40; G01S 7/481; G02B 1/00; G02B 27/42

(52) U.S. Cl. CPC G02B 27/0944; F21V 9/40; G01S 7/4817; G02B 1/002; G02B 27/4272

(57) ABSTRACT

System for free-space light coupling between 2-dimensional light transmitter and receiver arrays using flat optics. The system includes: a transmitter array configured to emit one or more light beams; a first flat optic configured to receive the light beams from the transmitter array and generate one or more intermediate light beams; a first spacer disposed between the light transmitter array and the first flat optic; a receiver array; a second flat optic configured to receive the intermediate light beams and generate one or more output light beams toward the receiver array; and a second spacer disposed between the second flat optic and the light receiver array. The TX and RX portions of the light coupling system may be used in LiDAR systems as the light emitter (beam steerer) and detector, respectively. The flat optics are configured to provide a wide field of view for the LiDAR.

### BACKGROUND OF THE INVENTION

This invention relates to optics and optical systems, and in particular, it relates to flat optics and their applications in optical and photonic systems.

Free-space light coupling between 2-dimensional light transmitter and receiver arrays offer considerable advantages for realizing high bandwidth density optical channels, which are essential to applications such as optical interconnects, photonic packaging, sensing, imaging, computing, etc. However, traditional free-space optical systems based on refractive and reflective optics typically require a number of precisely-aligned optical components to optimize the links, meeting the requirements such as coupling efficiency, mode matching, channel density, field-of-view, link distance, etc. These requirements result in highly complicated, bulky, and costly optical assemblies with limited performance.

Edge and surface-normal coupling are two main configurations for on/off-chip coupling into/out of PICs. Edge coupling can only access the perimeters of the chip and is also constrained by the large pitch of optical fibers. As a result, edge coupling is fundamentally limited in terms of bandwidth density. Moreover, edge coupling is only applicable to die-level characterization and incompatible with wafer-level testing. Surface-normal coupling typically leverages 2-D grating arrays which affords much higher bandwidth density and wafer-level testing compatibility. To date, grating couplers are almost invariably designed for coupling to optical fibers, with a mode field diameter of approximately 10 μm matching that of standard single-mode fibers.

Coupling into large-area free-propagating beams (either in emitting or receiving mode), despite its critical relevance to many space missions, has rarely been explored. Recently, grating couplers with expanded surface area have been investigated for coupling with high-power lasers or multi-mode fibers. However, these devices are not suited for coupling with high-quality (characterized by a small M² parameter close to unity) free-space beams (e.g., the multi-mode coupler cannot form high-quality beams due to multi-mode interference). Additionally, even these “large-area” gratings are only less than 100 μm in size. Optical phased array (OPA) combines a large number of individual emitters, each of which with tunable output phase, to realize wavefront control and beam forming. However, high-quality large-area beam forming using OPA stipulates a small emitter pitch and an enormous number of phase modulator elements. For example, the number of individually addressed emitters in an OPA with 1 mm² area operating in the near-IR is of the order of one million—not to mention even larger arrays. An alternative route involves discrete optical elements such as lenses or minors to transform the output from a point source (e.g., a small grating coupler) into a collimated beam. This approach has been adopted to enable high-throughput interrogation of on-chip device arrays, pluggable expanded-beam optical connectors with relaxed alignment tolerance, and lens-assisted beam steering. These examples resort to conventional bulky refractive or reflective optical elements, which considerably increase the module footprint and require sequential die or chip-level assembly with low throughput and yield.

LiDAR is an exemplary application where such a PIC-to-free-space light coupling mechanism will play a transformative role. LiDAR is a laser-based ranging technology for 3-D depth (distance) measurement featuring much higher precision compared to radar (LiDAR's radio-wave counterpart), and it has been widely deployed in metrology, robotics, environment monitoring, meteorology, remote sensing, and autonomous driving. Conventional LiDAR uses mechanically rotating light sources and detectors to cover the surrounding scene, which however limits the speed, resolution, ruggedness, compactness, and cost effectiveness of LiDAR systems. To address these limitations, solid-state LiDARs based on nanophotonic technologies exemplified by PIC-based OPAs and active metasurfaces have been extensively investigated in recent years. These solutions still face scaling challenges toward high-density large arrays important to practical deployment. First, aliasing-free operation across a wide field-of-view (FOV) stipulates a subwavelength (ideally ≤λ/2 or half wavelength) pitch, which leads to severe crosstalk as well as fabrication difficulties. Second, to achieve high-quality beam forming, a large-aperture (millimeter scale) array with precisely controlled optical phase profile is essential. However, a large subwavelength-pitch array points to a huge number (millions) of independently addressed, densely packed optical antennas—an integration and packaging challenge. In PIC-based OPAs, the challenge is usually mitigated by introducing wavelength tuning for beam steering along one direction, which nonetheless suffers from much smaller angular steering range. Lastly, the frame rate of these scanning LiDARs is inherently limited by the beam scanning speed and motion artifacts result.

### SUMMARY OF THE INVENTION

Embodiments of the present invention provide light coupling and beam shaping architectures based on flat optics, which offer high performance, small form factor and structural simplicity as compared to traditional optical approaches. The architectures can be used in a variety of optical systems including optical interconnects, photonic packaging, sensing, imaging, computing, etc.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides an optical coupling system which includes: a transmitter array including one or a plurality of light transmitters configured to emit one or a plurality of light beams; a first flat optic configured to receive the light beams from the transmitter array and generate one or a plurality of intermediate light beams; a first spacer disposed between the light transmitter array and the first flat optic; a receiver array including one or a plurality of light receivers; a second flat optic configured to receive the intermediate light beams and generate one or a plurality of output light beams toward the receiver array; and a second spacer disposed between the second flat optic and the light receiver array.

In preferred embodiments, the first and second flat optics are configured to provide optical relay or mode matching between the transmitter array and the receiver array. Each of the plurality of light transmitters is a light source or an optical channel coupled to an external light source, and each of the plurality of light receivers is a light sensor or an optical channel coupled to an external light sensor. The light transmitter array and/or the light receiver array may be a photonic integrated circuit.

In another aspect, the present invention provides a light beam steering system, which includes: a 2-dimensional light emitter array including a plurality of light emitters configured to emit a plurality of light beams; a first metasurface configured to receive the light beam from each light emitter of the light emitter array and generate one or multiple corresponding output light beams or light distribution pattern, the output light beams or pattern having at least one beam property that is dependent on a 2-dimensional position of the corresponding light emitter, the at least one beam property including direction, collimation, divergence, or intensity distribution, wherein the first metasurface is configured to generate output light beams over a field of view greater than 60 degrees with respect to a normal direction of the first metasurface; and first control circuitry coupled to the light emitter array to modulate or selectively turn on or off individual light emitters in the light emitter array.

In another aspect, the present invention provides a LiDAR (Light Detection and Ranging) system including a light emitter and a light detection, wherein the light emitter includes the above-described light beam steering system. The light detector of the LiDAR system includes a 2-dimensional light detector array including a plurality of light detectors; a second metasurface configured to receive light beams reflected from a target scene and focusing the light beams onto the light detector array, wherein the second metasurface is configured to receive light beams reflected from the target scene over a field of view greater than 60 degrees with respect to a normal direction of the second metasurface; and second control circuitry coupled to the light detector array to process signals generated by the light detector array.

It is to be understood that both the foregoing general description and the following detailed description are exemplary and explanatory and are intended to provide further explanation of the invention as claimed.

### BRIEF DESCRIPTION OF DRAWINGS

FIG. 1 schematically illustrates an optical coupling and interconnection system employing flat optics according to embodiments of the present invention.

FIG. 2 schematically illustrates an exemplary optical coupling and interconnection system employing flat optics according to an embodiment of the present invention.

FIG. 3 schematically illustrates an optical coupling and interconnection system employing flat optics with a folded optical path according to another embodiment of the present invention.

FIG. 4 schematically illustrates an optical coupling and interconnection system employing flat optics where one or both flat optics provide a micro-lens function according to another embodiment of the present invention.

FIG. 5 schematically illustrates an optical coupling and interconnection system employing flat optics used as an image inverter according to another embodiment of the present invention.

FIG. 6 schematically illustrates a light transmitter or light detector of a LiDAR (Light Detection and Ranging) system according to embodiments of the present invention.

FIG. 7 schematically illustrates a light transmitter of a LiDAR system according to another embodiment of the present invention.

### DETAILED DESCRIPTION OF THE INVENTION

Embodiments of the present invention provide optical coupling and interconnection architectures and designs based on flat optics. In embodiments of the present invention, metasurface optics, which employ sub-wavelength arrays of optical antennas or “meta-atoms” each designed to impart a specific phase delay, provide a new way for on-demand wavefront shaping. Unlike traditional refractive or reflective optics which are customarily made on bulk materials, metasurface optics boast a flat, low-profile form factor and are amenable to volume manufacturing via standard CMOS microfabrication and wafer-level assembly, making them ideally suited for scalable integration with PICs. Furthermore, metasurface-based coupling approach according to embodiments of the present invention enables compact systems with low-aberration wavefront control at large light incident/exiting angles, a fundamental challenge faced by conventional optical systems which usually necessitate a train of lenses to correct the aberrations.

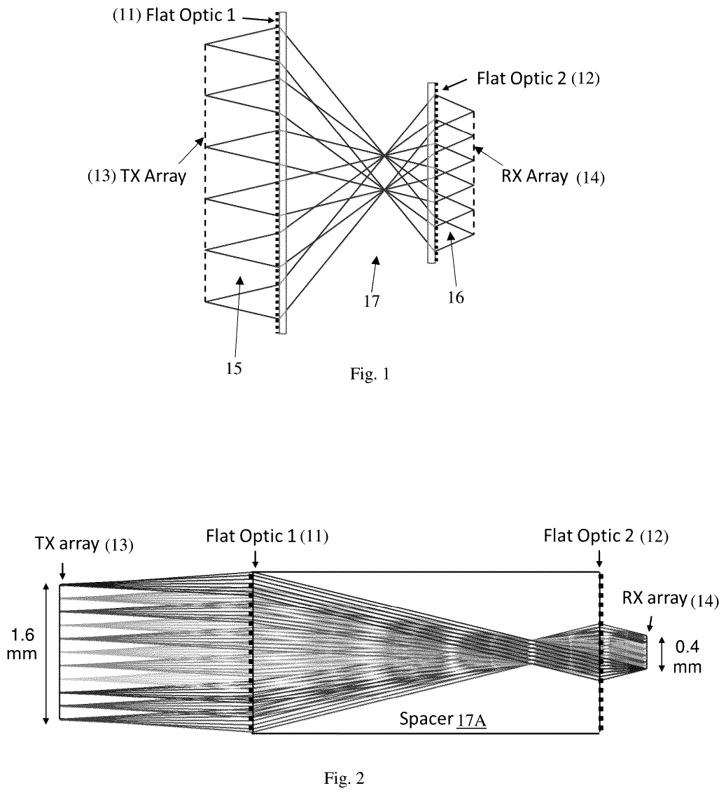

As schematically depicted in FIG. 1, an optical coupling system according to embodiments of the present invention includes a first flat optic 11 (Flat Optic 1) coupled to a light transmitter (TX) array 13 having a plurality of light transmitters, and a second flat optic 12 (Flat Optic 2) coupled to a light receiver (RX) array 14 having a plurality of light receivers. The coupling between the TX array and the first flat optic is via a spacer 15, which may be any optically transparent medium such as an air gap, a solid or liquid material, porous materials, metamaterials, etc. Likewise, the coupling between the second flat optic and the RX array, and the coupling between the first and second flat optics, are also via respective spacers 16 and 17 which may be air gaps or solid or liquid materials, porous materials, metamaterials, etc. It should be emphasized that the optical coupling between the flat optics 11 and 12 and the corresponding light transmitters 13 and receivers 14 involves 3-dimensional free space light propagation, e.g., coupling of light between a PIC and the space outside of the PIC. In other words, the flat optics 11 or 12 and the corresponding light transmitters 13 or receivers 14 are not integrated together into the same PIC.

The first flat optic 11 receives the light beams emitted by the TX array 13 and generates a plurality of intermediate light beams, and the second flat optic 12 receives the intermediate light beams and generates a plurality of output light beams toward the RX array 14. The first and second flat optics are configured to provide optical relay and/or mode matching between the TX and RX arrays. In one example, the first flat optic collimates light emitted from the TX array and steers the beams towards the second flat optic, and the beams are subsequently focused by the second flat optic onto the corresponding RX array. The optical system may be configured to realize perpendicular, oblique or any other types of beam coupling at the object and image planes. The image height or optical intensity pattern generated by the optical system can be further engineered to control the positions or distribution of the TX and/or RX spot arrays. Additional optical elements (e.g., flat optics, refractive and/or reflective optics, micro-lens array, etc.) may be incorporated in the optical coupling system to further improve the performance.

In this disclosure, flat optics may include but are not limited to sub-wavelength optics, metasurfaces, multi-layer metasurfaces, metamaterials, diffractive optical elements (DOE, e.g., binary, multi-level, or grayscale DOEs, etc.), holographic optical elements (HOE), wafer level optics (WLO), micro-optics, etc. One example of the flat optics is optical metasurfaces. Optical metasurfaces, also alternatively termed sub-wavelength diffractive optics, are artificial media comprising 2-dimensional (2-D) arrays of sub-wavelength optical structures (commonly called meta-atoms), typically positioned on a substrate. The meta-atoms and the substrate may be made of the same or different optical materials. The meta-atoms are designed to change the phase, amplitude, and/or polarization of the incident light. The meta-atoms may have the same or different geometries, dimensions, and orientations. Exemplary geometries may include rectangular, cylindrical, freeform, or any other suitable shapes or combinations of different shapes, etc. The lattice of the meta-atoms may have any suitable shape and period (e.g., square, rectangular, or hexagonal). The lattice may also be aperiodic, with varying or random distances between adjacent meta-atoms. In some examples, the gap between adjacent meta-atoms may be designed to have a constant gap distance.

The metasurface may be flat, curved or conformally integrated with the substrate. One or both sides of the substrate may be flat or curved. Both the metasurface and the substrate may be rigid, flexible, or stretchable. The geometries, dimensions, and layout of the meta-atoms and substrate are designed to provide the target optical functions. The metasurfaces may be designed to operate at a single wavelength, multiple wavelengths, or over a continuous spectral range.

The light transmitters may include light sources (e.g., lasers, light emitting diodes (LEDs)), and/or optical channels (e.g., optical fibers, optical waveguides, optical couplers, etc.) that transmit light from external light sources. The receivers may include light sensors such as photodetectors, and/or optical channels (e.g., fibers, waveguides, optical couplers, etc.) that transmit light to external light sensors. The light transmitter array and/or the light receiver array may be PIC devices. In addition to physical objects, the transmitters and receivers may be non-physical, such as images or light patterns generated by external light sources, or received by other optical components or systems, respectively. The light transmitters and receivers may have different physical sizes and/or orientations.

The light emitted by each light transmitter of the TX array (i.e., the incident light onto the first flat optic) has defined optical properties such as divergence angle, incidence angle with respect to the surface of the first flat optic, wavefront shape (non-spherical in some cases), wavelength, and/or polarization. The first flat optic is designed based on these optical properties of the incident light, as well as the properties required of the intermediate light beams output by the first flat optic such as divergence angles, output directions, wavefront shapes, polarization, wavelength, etc. On the RX side, the light output by the second flat optic is required to have defined optical properties, such as divergence angles, output directions, wavefront shapes, polarization, wavelength, etc., that are suitable for the RX array; the second flat optic is designed based on the optical properties of the intermediate light beams (i.e. the incident light onto the second flat optic) and the required optical properties of the output light of the second flat optic. By such designs, the first and second flat optics are able to provide optical relay and/or mode matching between the TX and RX arrays. As mentioned earlier, in one example, the first flat optic is configured to collimate light emitted from each light transmitter in the TX array and output the beams at defined angles towards the second flat optic, and the second flat optic is configured to focus each beam onto a corresponding one of the receivers in the RX array.

The exemplary optical system shown in FIG. 1 has a telecentric configuration on both the TX side and the RX side, i.e., the chief ray of the light emitted from each transmitter is normal to the first flat optic, and the chief ray of the output light beams toward each light receiver is normal to the second flat optic. In other examples, the optical system may be near-telecentric (where the chief rays are within approximately 20 degrees from the normal direction of the respective flat optic), or non-telecentric, or telecentric or near-telecentric on only the TX or RX side, etc.

Note that in the example shown in FIG. 1, the intermediate light beams all overlap in a common area on a plane between the two flat optics, but this is not required. Also, there is no requirement that the first and second flat optics be parallel to each other.

FIG. 2 illustrates an exemplary optical coupling system in which the first and second flat optics 11 and 12 (Flat Optic 1 and Flat Optic 2) are configured to relay a 1.6-mm-wide light source array (with a numerical aperture NA of approximately 0.05) as the transmitted (TX) array 13 to a 0.4-mm-wide fiber array (with a numerical aperture NA of approximately 0.22) as the receiver (RX) array 14. The ultra-compact design employs only two flat optics layers separated by a spacer 15. Optical simulation (raytrace simulation, FIG. 2) yields high-density, diffraction-limited coupling and precise mode matching between the TX and RX arrays. The total track length of the optical system is 8.8 mm and can be further adjusted. In some examples, the spacer may be formed of air, glass, polymer, semiconductors, or other suitable optical materials. Other aspects of this embodiment are similar to those of the embodiment of FIG. 1.

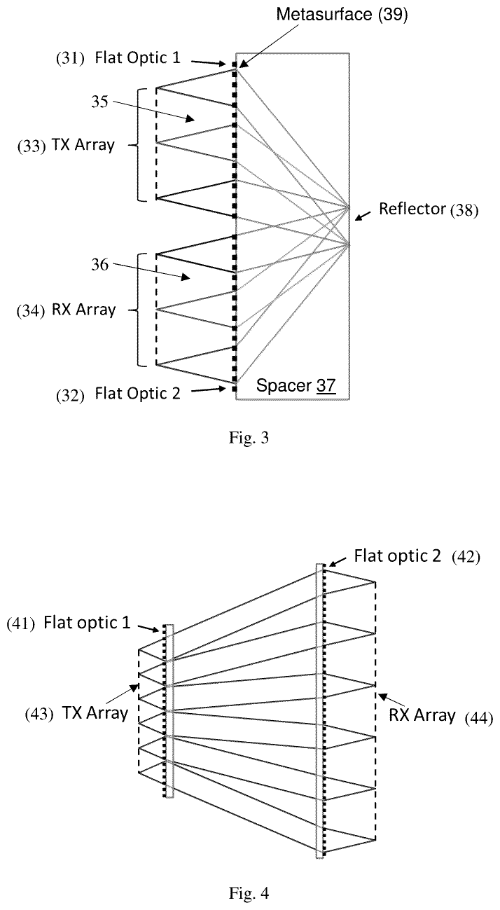

FIG. 3 schematically illustrates another optical coupling architecture using flat optics with a folded optical path. The system includes a metasurface 39, a spacer 37, and a reflector 38, where the metasurface 39 and the reflector 38 are located on two opposite sides of the spacer 37. The metasurface 39 includes one or multiple regions, e.g., a first flat optic region 31 (Flat Optic 1) and a second flat optic region 32 (Flat Optic 2). The first flat optic region is coupled to a light transmitter (TX) array 33 via a spacer 35, and the second flat optic region is coupled to a light receiver (RX) array 34 via a spacer 36. Spacers 35 and 36 may be formed by the same physical layer. Light beams emitted from the TX array 33 are coupled by the first flat optic region 31 and redirected towards the reflector 38. The reflector reflects, reshapes and/or redirects the beams towards the second flat optic region 31, where they are further coupled to the RX array 34.

The first and second flat optic regions and the reflector are configured to provide optical relay and/or mode matching between the transmitter and receiver arrays. In one example, the first flat optic region 31 collimates light emitted from the transmitter array 33 and directs the beams towards a flat mirror 38, where the beams are reflected towards the second flat optic region 32 and subsequently focused by the second flat optic region onto the corresponding receiver array 34. The optical system may be configured to realize perpendicular, oblique or any other types of light coupling at the object and image planes. The reflector 38 may be flat, curved, or in any other geometry to redirect and/or re-shape the light. The reflection may be based on reflective coatings or structures, diffraction, metasurfaces, and/or total internal reflection. Additional optical elements (e.g., flat optics, refractive and/or reflective optics, micro-lens array, etc.) may be incorporated into the system to further improve the performance. Other aspects of this embodiment are similar to those of the embodiment of FIG. 1.

In another embodiment shown in FIG. 4, one or both of the first and second flat optics 41 and 42 is configured to provide the function of a micro-lens array in which different non-overlapping regions of the first flat optic 41 are designated to coupling to different TX channels 43, and/or different non-overlapping regions of the second flat optic 42 are designated to coupling to different RX channels 44. For example, in the example shown in FIG. 4, the first flat optic 41 directs the intermediate beams corresponding to individual light transmitters of the TX array 43 to separate non-overlapping regions of the second flat optic 42, where each region only generates output light beam corresponding to one light receiver. Other aspects of this embodiment are similar to those of the embodiment of FIG. 1.

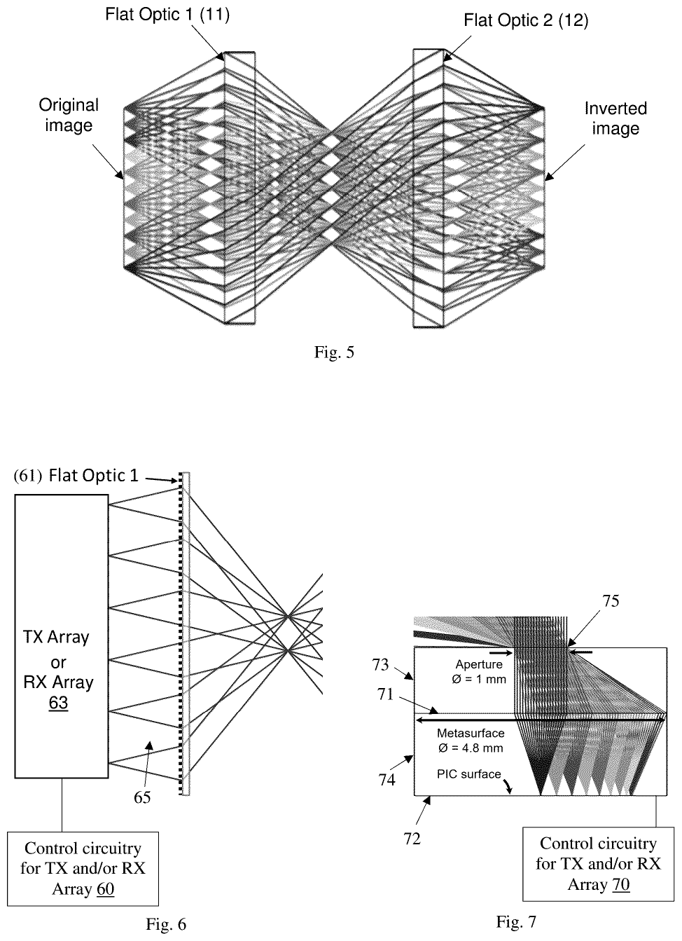

FIG. 5 schematically illustrates an optical coupling system used as a metasurface-based image inverter (meta-inverter), which can invert an image with significantly improved compactness, e.g., aspect ratio (total track length to image height ratio) of approximately 2:1 or lower, as compared to aspect ratio of 4:1 or higher using traditional optical systems. To form an image inverter, both the first flat optic 11 and second flat optic 12 are collimating lenses, and the chief rays of all intermediate beams pass through a common point. In some embodiments, the first and second flat optics have the same size to generate an inverted image having the same size as the original image on the TX side. In some embodiments, the structures of the first and second flat optics are symmetrical to each other with respect to the center of the flat optics. As noted earlier, the TX array and RX array may be non-physical, such as images or light patterns (or intermediate images) generated by external light sources, or received by other optical components or systems, respectively. Other aspects of this embodiment are similar to those of the embodiment of FIG. 1.

Another embodiment of the present invention provides a hybrid PIC-metasurface based LiDAR system. It uses a chip-scale packaged platform to enable efficient coupling between photonic integrated circuits (PICs) and free-space, producing high-quality (e.g., diffraction limited), large-area (e.g., 10's μm to millimeters in diameter or larger) and dense-arrayed beams. This technology can be utilized to realize a chip-scale optical engine for light detection and ranging (LiDAR) with unprecedented ultrawide field-of-view (FOV), low loss, and high frame rate. This optical coupling interface will significantly facilitate the implementation of PIC technologies in various applications, e.g., navigation, communications, sensing, etc., where coupling of PICs with a large-area free-space beam offers many benefits, such as light-weight, compact, and high-performance. Additionally, the LiDAR technology will also broadly impact other applications such as robotic control, unmanned aerial vehicle (UAV) navigation, automotive sensing, and consumer electronics.

In this LiDAR system, metasurface-based beam steering is used to project optical beams or patterns toward a target scene with a wide field of view (FOV). The light sources behind the metasurface can be individually controlled to direct, steer, toggle, or adjust the beams over a broad area. The same expansive field of view metalens used for projecting light can also be employed in the LiDAR device's receiver to collect signals over a large area.

As the overall structures and operating principles of LiDAR systems are generally known, the descriptions below focus on the metasurface-based light emitter and metasurface-based light detector of the LiDAR system.

FIG. 6 illustrates the structure of a metasurface-based light emitter or light detector of a LiDAR system according to embodiments of the present invention. In the case of a light emitter, component 63 is a light transmitter (TX) array; in the case of a light detector, component 63 is a light receiver (RX) array. As shown in FIG. 6, the metasurface-based light emitter or light detector includes a flat optic 61 optically coupled to the TX or RX array 63 via a spacer 65. In the case of a light emitter, the TX array 63 includes a 2-D array of light emitters such as light sources (e.g., VCSELs (vertical-cavity surface-emitting lasers), LEDs (light emitting diodes), etc.), or PIC (photonic integrated circuit) couplers, waveguides, optical fibers, etc. that transmit light from external light sources. In the case of a light detector, the RX array 63 includes light sensors such as photodetectors, and/or optical channels (e.g., fibers, waveguides, optical couplers, etc.) that transmit light to external light sensors.

In the case of a light emitter, the flat optic 61 may be a metasurface (the emitter metasurface) formed of an array of meta-atoms, where each meta-atom may be individually configured to emit light at different phases, amplitudes, and polarization states. The emitter metasurface is configured to receive divergent incident light beams emitted by each light emitter, and collimate the beam to generate a corresponding collimated output beam; the output direction of the corresponding output beam is dependent on the 2-D position of the incident light beam, i.e., it is dependent on the physical position of the particular light emitter in the 2-D light emitter array. The light emitters in the array are individually controlled by control circuitry 60 to turn on and off and/or to modulate the phase of the emitted light. As a result, the directions of the output light beams generated by the metasurface are controlled by the control circuitry 60. This way, the metasurface emitter array achieves shaping and steering of the light beam across a range of angles without mechanical movement.

More generally, the emitter metasurface is configured such that at least one optical property of the output beam, such as direction, collimation, divergence, or intensity distribution, is dependent on the 2-dimensional position of the corresponding light emitter.

The emitter metasurface may be configured to generate 1 to 1 emission (i.e., one light emitter generates one output beam), 1 to N emission (i.e., one light emitter generates multiple output beams), or pattern emission (i.e., one light emitter generates an output beam pattern).

The light emitter array 63 may be implemented by optical waveguides, an array of emitters to couple light from waveguides to free space, a switch network to route the light to individual emitters, as well as a modulator array to modulate the output light. Such switched light emitter arrays are known in the art and more detailed descriptions are omitted here.

In preferred embodiments, the emitter metasurface is configured to have a wide FOV, for example, at least ±30 degrees relative to the normal direction of the metasurface, and preferably, as wide as ±90 degrees relative to the normal direction (i.e. 180 degree FOV). This wide FOV is achieved by the design of the emitter metasurface and related optical structures as will be described in more detail later.

The metasurface for the light detector (the detector metasurface) may have similar structures and properties as the emitter metasurface described above. The detector metasurface is configured to receive the light beams reflected from the target scene, over a wide FOV, and focus or re-direct the beams onto the light receiver array 63.

A specific example of a light emitter (or light detector) for a LiDAR system according to an embodiment of the present invention is shown in FIG. 7. Component 72 is a light transmitter array such as light sources or PIC couplers in the case of a light emitter or a light receiver array such as light detectors or PIC couplers in the case of a light detector. The system operates at the 1550 nm band which is deemed eye-safe, but can be readily applied to other wavelengths. The metasurface 71 is formed of a-Si nano-pillars immersed in an epoxy layer and is sandwiched between two glass spacers 73 and 74. An aperture 75 is formed on the top surface of the top spacer 73 facing the target; the aperture and the metasurface 71, separated by the spacer 73, together form a wide FOV metalens. In this example, the metalens has an aperture size of 1 mm and a numerical aperture (NA) of 0.20 (f/#=2.5). The NA can be adjusted to match the divergence angle of the light transmitters of the TX array 72 (or the spot size for the light receivers of the receiver array) to maximize the coupling efficiency. In a preferred embodiment, the metalens assumes a telecentric configuration, which contributes to aberration suppression. Additionally, the configuration ensures that the chief ray angle of the light beam emitted by the light transmitters toward the metasurface (or the light beam generated by the metasurface toward the light receivers) is close to zero with respect to the normal direction of the metasurface regardless of the light beam exit (or incident) angle of the LiDAR device. This is an important advantage for LiDAR, since it avoids angle-dependent spectral drift of LiDAR-integrated filters, allowing the use of a single bandpass filter to efficiently reject ambient background light from the entire FOV. The metalens (fisheye lens) maintains diffraction-limited focusing quality for all beam exit (or incident) angles (up to 180° FOV). At extreme beam exit (or incident) angles (80° and above relative to the normal direction), the efficiency may drop because of the Fresnel reflection loss, which can be mitigated with appropriate surface texturing or angularly-dependent metasurface designs. The LiDAR's angular resolution is dictated by the pitch of the coupler array for either light emitting or detecting, and a coupler pitch of 10 μm yields approximately 0.2° resolution, compliant with the requirements of most practical applications. An additional metasurface may be used to further enhance the performance, such as correction of barrel distortion at large AOIs (angle of exit or incidence). Further resolution improvement is possible using coupler and waveguide arrays with sub-10-μm pitch.

The metasurface detector array shown in FIG. 7 can provide directional information about the incoming light, making it easier to reconstruct a three-dimensional image of the environment. Furthermore, the metasurface may provide angular, spectral, and/or polarization modulation functions (e.g., filtering). As a result, information within certain angular, spectral, and/or polarization ranges may be extracted, removed, and/or modulated.

In one example, to fabricate the metasurface, the a-Si film is deposited via plasma enhanced chemical vapor deposition and then patterned using electron beam lithography and plasma etching. After metasurface patterning, a layer of SU-8 epoxy is spin-coated to enhance ruggedness of the nano-post meta-atoms. SU-8 can completely fill in the spacing between meta-atoms without leaving any residual air pockets, and can also produce a flat, fully planarized top surface suitable for subsequent bonding integration.

In actual implementations, the emitter and detector metasurfaces may share the same portions of a metasurface.

Note that the LiDAR emitter or detector system shown in FIG. 6 does not include an aperture, while the emitter or detector system shown in FIG. 7 has an aperture 75. In embodiments of the present invention, the LiDAR emitter typically does not employ an aperture, although one may be used; the LiDAR detector typically employs an aperture, although one is not required. For the emitter, the light transmitters have defined divergence angle (NA) which are typically within the control of the system designer, so the phase profile of the emitter metasurface may be designed to produce wide FOV output light and high imaging performance without using an aperture. If the NA of the light transmitters is large, sometimes a physical aperture may be used to reduce aberration.

On the receiver side, because the incident light may arrive from any arbitrary incident direction, an aperture is typically employed to achieve wide-FOV. In some examples, a physical aperture is provided, such as in the example of FIG. 7, so that lights from different AOIs are directed to the designated regions on the metasurface. Alternatively, the system may employ a virtual or self-formed aperture defined by the metasurface so that it modulates the light differently depending on the AOI. For example, the metasurface may be designed to have local angle-dependent responses so that it provides different angular-filtering effects at different regions, therefore forming a virtual aperture for different AOIs. These angle-dependent responses may be enabled by meta-atom designs that exhibit different phase and/or amplitude responses at different AOIs. The system may also include pixelated or non-pixelated angle dependent filters, e.g., DBR filters, to provide such spatially-varying angular selectively.

In an optical interconnection systems involving both TX and RX with pre-defined optical paths (such as the systems shown in FIGS. 1-5)—where, for example, the light beams from the TX flat optic are directed towards a small overlapping region between the first and second flat optics, no aperture is required on either the TX or RX side.

The LiDAR system additionally includes a modulation and processing unit (e.g., a processor or computer), that controls the light emission patterns, performs frequency modulation for range finding, and optionally, phase modulation for improved resolution. It also processes the returning light signals from the target to compute the distance and reflectivity of target objects in the environment. The LiDAR system preferably also includes integrated electronics and circuitry for rapid modulation of the light, data acquisition, and initial processing. It may employ AI (artificial intelligence) components for real-time data processing and object recognition. These processing units and circuitry are schematically represented by components 60 and 70 in FIGS. 6 and 7. The processing units and circuitry may be a distributed system having multiple units that communicate and cooperate with each other to perform all necessary control and data processing functions of the LiDAR system. The control and data processing methods for LiDAR systems are generally known and further details are omitted here.

In the LiDAR system of this embodiment, by specific designs of the emitter metasurface and control of the emission of the light emitter array, various desirable functions may be accomplished in addition to beam steering. Some examples are described below.

High-resolution imaging: Fine control over light emission and detection allows for detailed images and accurate depth measurements. This enables detection of small features that may be missed by conventional LiDAR systems. For example, certain portions of the emitter metasurface are designed to generate beams with different properties, e.g., beams with different collimation, divergence or focusing properties; light emitters at locations corresponding to such metasurface portions may be selectively turned on, to generate beams with desired properties to achieve the needed imaging and/or sensing function. For example, certain portions of the emitter metasurface are designed to generate focused light beams with smaller spot sizes; light emitters at locations corresponding to such metasurface portions may be selectively turned on, to generate focused light beams to achieve higher resolution imaging.

Adaptive illumination: The system may be controlled to dynamically adjust the illumination pattern based on the environment. For example, it may be controlled to concentrate light on areas of interest for more detailed scanning. More specifically, certain portions of the emitter metasurface are designed to generate focused light beams, and certain other portions of the emitter metasurface are designed to generate divergent light beams; light emitters at locations corresponding to different metasurface portions may be selectively turned on based on illumination need, for example, to generate focused light beams, divergent light beams, or light beams of any other desired illumination patterns. Light beams emitted from different emitters may be combined coherently or incoherently to generate desired amplitude and/or phase patterns, to achieve desired interferometric effect.

Multi-functionality: The system may be controlled to switch between different LiDAR modes, such as switching across multiple operation states, such as short-range and long-range probing and/or narrow and wide FOV scanning. More specifically, certain portions of the emitter metasurface are designed to generate collimated beams, and certain other portions of the emitter metasurface are designed to generate diverging beams; light emitters at locations corresponding to different metasurface regions may be selective turned on to achieve different spot sizes for short-range, wide-angle scanning or long-range, narrow-field probing.

To summarize, the emitter metasurface may be designed so that different portions of the metasurface are configured to generate light beams of different characteristics such as divergence angles and beam directions, and light emitters at corresponding locations may be selectively turned on to generate illumination beams of desired characteristics to achieve desired functions. Such a light emitter may have applications as an illumination device outside of the LiDAR field.

The emitter metasurface may also be designed so that overlapping or partially-overlapping portions of the metasurface are configured to generate light beams of different characteristics such as divergence angles and beam directions, and light emitters at corresponding locations may be selectively turned on to generate illumination beams of desired characteristics to achieve desired functions. Further, the metasurface may provide angular, spectral and/or polarization dependent responses so that light with different properties or emitted from sources of different properties may be modulated differently (e.g., deflected to different directions). The emitter array may include emitters with different wavelengths or polarization states. The emitter array may include filters with different spectral or polarization filtering properties.

The LiDAR system according to this embodiment can achieve a compact and robust design. The lack of moving parts reduces mechanical complexity, size, weight, and wear, leading to more durable and portable systems.

The metasurface-based LiDAR systems described here are useful in fields where precision mapping and sensing are crucial. This includes autonomous vehicles, robotics, aerospace, and various forms of remote sensing. With advancements in metasurface technology, the system can be further miniaturized, possibly leading to its integration into smartphones and other personal electronic devices for augmented reality applications and spatial computing.

Embodiments of the present invention provide a chip-scale platform that allows efficient coupling from single-mode PICs to a large-area, diffraction-limited beam, and further exploit this technology to realize a chip-scale LiDAR system with unprecedented ultrawide FOV, low loss, and high frame rate.

In some embodiments, the coupling scheme uses a flat fisheye metalens to transform optical output from a PIC to a collimated beam with high quality (or any other desired beam intensity/phase distribution). The PIC processing may leverage standard photonic foundry manufacturing. The metalens integration is also amenable to a wafer-scale process and will result in a thin, chip-scale package. In addition to its compatibility with scalable manufacturing and integration techniques, the scheme is also unique in its ability to couple to a large-area (several millimeters in diameter or larger) free-space beam while maintain near diffraction-limited beam quality. This capability leads to a small beam divergence (0.001 to 0.01 degree) and exceptional beam directionality from a chip-scale module, which is very helpful for applications such as LiDAR and free-space laser communications.

In some embodiments, the coupling optics employs a flat fisheye metalens, having a structure similar to that shown in FIG. 7. It comprises a single piece of flat transparent substrate 73 with an optional aperture 75 positioned on the front surface and a metasurface 71 positioned on the back surface (facing the light transmitter array or the light receiver array). Light beams incident on or exiting the optical structure at different angles of incidence or exit (AOIs) are modulated (e.g., focused) by the metasurface. When the metasurface phase function ϕ fulfills the closed-form solution all focal spots across the entire FOV will fall on the same image plane with minimal coma aberration

$$ϕ ( r ) = \frac{2 π}{λ} \cdot {\int }_{0}^{r} ( \frac{nr}{\sqrt{{r}^{2} + {L}^{2}}} + \frac{r - h}{\sqrt{{f}^{2} + {( r - h )}^{2}}} ) \cdot dr , \qquad ( 1 )$$

where r, λ, n, L, and f denote the radial position from the lens center, wavelength, substrate refractive index, substrate thickness, and effective focal length, respectively. h is the focal spot position (i.e., image height or emitter position in imaging or emitter configurations, respectively) that correspond to the FOV angle, and it can be given in a differential form in relation to AOI=θ:

$$\frac{dh}{d θ} = [ {( \frac{L sin θ}{\sqrt{{n}^{2} - {sin}^{2} θ}} - h )}^{2} + {f}^{2} ] \cdot \frac{cos θ}{{f}^{2}} . \qquad ( 2 )$$

The above equations indicate that a flat substrate, when decorated with a single-layer metasurface, can be transformed into a fisheye lens with near-180° diffraction-limited FOV. Moreover, the planar focal surface enables considerably simplified optical system architectures.

While a metasurface phase function ϕ for a fisheye lens with near-180° FOV is given above, more generally, a wide FOV metalens (e.g., one with a FOV of 60° or more relative to the normal direction) may be achieved using numerical optimization methods. For emitters, a near-telecentric architecture is preferred for achieving a wide FOV, and the divergence (numerical aperture) of the metalens is preferably designed to match those of the emitter array. More generally, the metalens is designed to achieve wavefront or mode matching between the emitter and the far-field beam via metasurface modulation.

Unlike traditional approaches where a discrete lens must be manually aligned with the light source or PIC, the architecture according to embodiments of the present invention allows the metalens (including the optional aperture stop, optical filter, and spacer as needed) to be bonded to the PIC at the wafer scale with lithographic precision, followed by dicing and die singulation to individual chip-scale modules. This process facilitates assembly of a large number of modules at the wafer level in a parallel manner, sidestepping the laborious and costly optical alignment and packaging step for each single device. This is the same rationale motivating the emergence of wafer-level optics (WLO) in place of discretely assembled optics, although metasurfaces overcome several longstanding challenges plaguing WLO including precision optical surface shape control (especially for aspherical and free-form surfaces), cross-wafer variability, and yield. Moreover, metasurfaces also enable efficient light bending even at large angles—an essential ingredient of designing compact optical systems with a large FOV.

In one embodiment, the PIC for LiDAR engine contains a modulator array to modulate the output light, a switch network to route the light, an emitter array to couple light from waveguides to the metalens, and a receiver for reflected signal collection (e.g., an on-chip coherent receiver for frequency-modulated continuous-wave FMCW LiDAR). The laser source may be integrated on an active interposer. The PIC components may include, but are not limited to, low-loss waveguides, waveguide coupler/emitter, high-speed modulators, 2×2 optical switches, and analog/digital photodetectors. Key requirements for the coupler include: 1) a spot size matching that of the metalens focal spot; 2) a beam divergence angle specified by the effective numerical aperture (NA) of the metalens; 3) minimal insertion loss and back reflection; and 4) a compact footprint commensurate with high-density array integration. Photonic inverse design protocols may be employed to design the couplers.

As a result, the described LiDAR platform circumvents the limitations facing current nanophotonic LiDAR technologies in scalability, FOV, beam quality and speed.

In terms of scalability, unlike LiDARs based on OPA and active metasurfaces, the system according to embodiments of the present invention is inherently free of aliasing and is not subjected to the λ/2 pitch constraint. Moreover, unlike OPAs which require N² individually phase-modulated emitters across the aperture, the above-described LiDAR system only needs log 2(N²)=2 log 2(N) switches to direct light to an N×N emitter array. The logarithmic network topology drastically reduces the complexity of electronic control.

In terms of FOV and beam quality, capitalizing on the flat fisheye lens design principle, the above-described LiDAR system uniquely combines a record FOV close to 180°, diffraction-limited beam quality, and high optical efficiency. The design is also readily scalable to large metalens aperture sizes (millimeters to even centimeters) while maintaining diffraction-limited performance, enabling high-quality beam forming with minimal divergence and high pointing accuracy, a feature particularly helpful in long-range LiDAR applications.

In terms of speed, unlike OPAs or active metasurfaces where the beam must be sequentially scanned, the above-described LiDAR system allows multiple emitters to concurrently transmit and receive signals, thereby achieving concurrent multi-channel operation. These emitters share the same metalens aperture and each addresses a single channel in the point cloud. The parallel interrogation scheme enhances the overall speed and frame rate. In addition, distinct modulation formats can be adopted across different groups of concurrently operating emitters to dramatically reduce optical crosstalk and sensitivity to background ambient light.

It will be apparent to those skilled in the art that various modification and variations can be made in the metasurface-based optical coupling and interconnection systems of the present invention without departing from the spirit or scope of the invention. Thus, it is intended that the present invention cover modifications and variations that come within the scope of the appended claims and their equivalents.

1. An optical coupling system comprising:
a transmitter array including one or a plurality of light transmitters configured to emit one or a plurality of light beams;
a first flat optic configured to receive the light beams from the transmitter array and generate one or a plurality of intermediate light beams;
a first spacer disposed between the light transmitter array and the first flat optic;
a receiver array including one or a plurality of light receivers;
a second flat optic configured to receive the intermediate light beams and generate one or a plurality of output light beams toward the receiver array; and
a second spacer disposed between the second flat optic and the light receiver array.

2. The optical coupling system of claim 1, wherein the first and second flat optics are configured to provide optical relay or mode matching between the transmitter array and the receiver array.

3. The optical coupling system of claim 1, wherein chief rays of the light beams emitted by the transmitter array are within 20 degrees from a normal direction of the first flat optic, and chief rays of the output light beams generated by the second flat optic are within 20 degrees from a normal direction of the second flat optic.

4. The optical coupling system of claim 1, wherein the intermediate beams generated by the first flat optic are collimated beams.

5. The optical coupling system of claim 1, wherein each of the first spacer and the second spacer includes one or more of an air gap, an optically transparent solid or liquid material, a porous material, and metamaterials.

6. The optical coupling system of claim 1, wherein each of the first and second flat optics includes one or more of: sub-wavelength optics, metasurfaces, multi-layer metasurfaces, a metamaterial, diffractive optical elements, holographic optical elements, wafer level optics, and micro-optics.

7. The optical coupling system of claim 1, wherein each of the plurality of light transmitters is a light source or an optical channel coupled to an external light source, and each of the plurality of light receivers is a light sensor or an optical channel coupled to an external light sensor.

8. The optical coupling system of claim 1, wherein the light transmitter array is a photonic integrated circuit, and/or the light receiver array is a photonic integrated circuit.

9. The optical coupling system of claim 1, wherein the transmitter array and the receiver array have different physical sizes and/or orientations.

10. The optical coupling system of claim 1, further comprising one or more optical elements configured to transmit the intermediate light beams from the first flat optic to the second flat optic.

11. The optical coupling system of claim 10, wherein the one or more optical elements includes a third spacer disposed between the first flat optic and the second flat optic.

12. The optical coupling system of claim 10, wherein the one or more optical elements includes a reflector.

13. The optical coupling system of claim 12, wherein the one or more optical elements further includes a third spacer, wherein the first and second flat optics are regions of a metasurface formed on one surface of the third spacer, and the reflector is formed on an opposite surface of the third spacer.

14. The optical coupling system of claim 1, wherein different non-overlapping or partially-overlapping regions of the first flat optic are designated to coupling to different ones of the plurality of light transmitters, or different non-overlapping or partially-overlapping regions of the second flat optic are designated to coupling to different ones of the plurality of light receivers.

15. The optical coupling system of claim 1, wherein the first flat optic and second flat optic are configured to form an image inverter.

16. A light beam steering system comprising:
a 2-dimensional light emitter array including one or a plurality of light emitters configured to emit one or a plurality of light beams;
a first metasurface configured to receive the light beam from each light emitter of the light emitter array and generate one or multiple corresponding output light beams or light distribution pattern, the output light beams or pattern having at least one beam property that is dependent on a 2-dimensional position of the corresponding light emitter, the at least one beam property including direction, collimation, divergence, or phase or intensity distribution,
wherein the first metasurface is configured to generate output light beams over a field of view greater than 60 degrees with respect to a normal direction of the first metasurface; and
first control circuitry coupled to the light emitter array to modulate or selectively turn on or off individual light emitters in the light emitter array.

17. The light beam steering system of claim 16, wherein the first metasurface has a phase function ϕ
$$ϕ ( r ) = \frac{2 π}{λ} \cdot {\int }_{0}^{r} ( \frac{nr}{\sqrt{{r}^{2} + {L}^{2}}} + \frac{r - h}{\sqrt{{f}^{2} + {( r - h )}^{2}}} ) \cdot dr , \qquad ( 1 )$$
where r, λ, n, L, and f denote a radial position from a center of the first metasurface, a wavelength of the light beam, a refractive index of the substrate, a thickness of the substrate, and an effective focal length, respectively, wherein h is a focal spot position that corresponds to the field of view, and wherein h is given in a differential form in relation to an angle of incidence θ:
$$\frac{dh}{d θ} = [ {( \frac{L sin θ}{\sqrt{{n}^{2} - {sin}^{2} θ}} - h )}^{2} + {f}^{2} ] \cdot \frac{cos θ}{{f}^{2}} . \qquad ( 2 )$$

18. A LiDAR (Light Detection and Ranging) system including a light emitter and a light detector, wherein the light emitter includes the light beam steering system of claim 16.

19. The LiDAR system of claim 18, wherein the light detector comprises:
a 2-dimensional light detector array including one or a plurality of light detectors;
a second metasurface configured to receive light beams reflected from a target scene and focusing the light beams onto the light detector array,
wherein the second metasurface is configured to receive light beams reflected from the target scene over a field of view greater than 60 degrees with respect to a normal direction of the second metasurface; and
second control circuitry coupled to the light detector array to process signals generated by the light detector array.

20. The LiDAR system of claim 19, wherein the light emitter further comprises an aperture located at a defined distance from the first metasurface.

21. The LiDAR system of claim 19, wherein the light detector further comprises an aperture located at a defined distance from the second metasurface.

22. The LiDAR system of claim 21, wherein the second metasurface forms a virtual aperture, wherein the second metasurface has local angle-dependent responses to provide different angular-filtering effects at different regions, thereby forming the virtual aperture for different angles of incidences.

23. The LiDAR system of claim 19, wherein the first or the second metasurface is configured to provide angular, spectral and/or polarization dependent responses.

24. The LiDAR system of claim 23, wherein the light emitter array includes light emitters having different wavelengths or polarization states.

25. The LiDAR system of claim 19, wherein the first metasurface has different portions that are configured to generate light beams of different divergence angles, and wherein the first control circuitry is configured to modulate or selectively turn on or off light emitters at locations corresponding to the different portions of the metasurface to generate illumination beams of defined characteristics.

26. A light illumination device comprising:
a 2-dimensional light emitter array including one or a plurality of light emitters configured to emit one or a plurality of light beams;
a metasurface configured to receive the light beam from the light emitter or each light emitter of the light emitter array and generate one or multiple corresponding output light beams or light distribution pattern, the output light beams or pattern having at least one beam property that is dependent on a 2-dimensional position of the corresponding light emitter, the at least one beam property including direction, collimation, divergence, or phase and/or intensity distribution; and
control circuitry coupled to the light emitter or light emitter array to modulate or selectively turn on or off individual light emitters in the light emitter array.

27. The light illumination of claim 26, wherein the metasurface has different portions that are configured to generate light beams of different divergence angles, and wherein the control circuitry is configured to modulate or selectively turn on or off light emitters at locations corresponding to the different portions of the metasurface to generate illumination beams of defined characteristics.

28. The light illumination of claim 26, wherein metasurface is configured to provide angular, spectral and/or polarization dependent responses, and wherein the light emitter array includes light emitters having different wavelengths or polarization states.
